(19) United States
(12) Patent Application Publication
(10) Pub. No.: US 2008/0186316 A1
(43) Pub. Date: Aug. 7, 2008

(54) Minimized Table Lookup

(75) Inventor: Howard G. Sachs, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telairity Semiconductor, Inc., Santa Clara, CA (US)

(21) Appl. No.: 11/670,063

(22) Filed: Feb. 1, 2007

(51) Int. Cl. G06T 1/00

(52) U.S. Cl. 345/522

(57) ABSTRACT

A system for providing data from a lookup table more efficiently includes a video processing engine which provides a pixel address as an output signal. A leading zero detector receives the pixel address and determines the number of leading zeros in the pixel address. Based on the number of leading zeros, a lookup table is accessed, which in return provides the necessary data to the video processing engine.

### BACKGROUND OF THE INVENTION

This invention relates to lookup tables, and in particular to an improved method and apparatus for storing and retrieving information in lookup tables.

A lookup table can be considered as a data structure, usually in the form of an array, which is used to replace a run-time computation with a simpler lookup operation. Typically, the addresses are sequential from zero to the maximum size needed, and each address is associated with a data value. For example, a lookup table may be provided for trigonometric computations. Thus, rather than calculating the cosine of a different angle each time that information is required by an application program operating on a computer, the application can reference a lookup table in which the addresses correspond to various angles, and the data in the array provides the cosine for that angle.

The invention described here relates to a technique for improving the speed of operation and the retrieval of information for video-related data from a lookup table.

### BRIEF SUMMARY OF THE INVENTION

In one embodiment a system for providing data from a lookup table includes a video processing engine which provides a pixel address as an output signal. A leading zero detector receives the pixel address as an input signal and provides a corresponding address in response. A lookup table is then accessed based upon the corresponding address, which in return provides the necessary data to the video processing engine.

In another embodiment of the invention, a method for performing faster table lookup operations in a computing system where the lookup table contains redundant information includes the steps of creating a lookup table having a series of values associated with addresses, some of the values being used more than once in the table, and organizing the table in a manner so that all entries having the same value have the same number of leading zeros in their addresses. When a value is to be retrieved, the number of leading zeros is used as an index into the table to select data based upon the number of leading zeros. Using the number of leading zeros as the address, the value is retrieved and used in an image processing operation, or other desired operation.

### BRIEF DESCRIPTION OF THE DRAWINGS

FIG. 1 illustrates a lookup table having redundant information;

FIG. 2 illustrates a lookup table in which pixel numbers, pixel addresses, and data values are correlated;

FIG. 3 is a table similar to FIG. 2 with additional information designating a weight table address;

FIG. 4 is a table similar to FIG. 3 with 15 entries to provide additional capability; and

FIG. 5 is a block diagram illustrating use of the weight table in conjunction with a motion estimation engine.

### DETAILED DESCRIPTION OF THE INVENTION

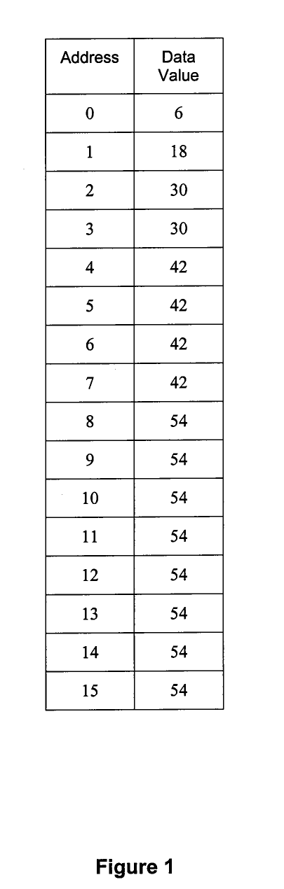

FIG. 1 is a lookup table illustrating addresses and corresponding data values. The lookup table is organized as an array where each address contains a data value. The addresses are sequential from 0 to 15 (in the depicted illustration) with each referencing a data value. The data values, however, include redundant information in the sense that for some addresses the same data value is used. In the case of FIG. 1, the data repeats in a binary fashion in accordance with the equation 2ⁿ starting with address 1. FIG. 1 is an example of a weight table as might be used in implementation of a video processing system in which multiple pixel addresses may be given the same weight, depending, for example, on the distance of that pixel from a particular location.

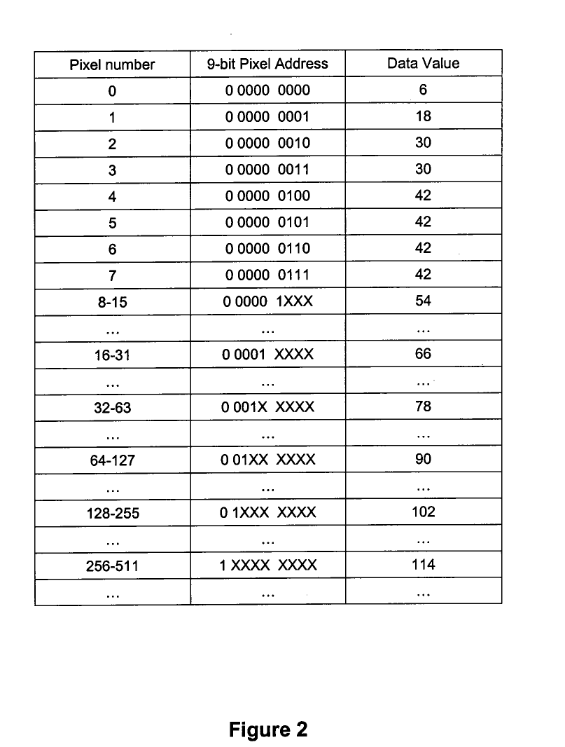

In commercially significant implementations of video compression systems, such as the Motion Picture Experts Group (MPEG)-4 standard, also known as H.264, the table may have as many as 512 addresses, but only ten different data values. In implementations such as this, as the original table becomes larger, the number of unique data values may grow slowly while the size of the table grows almost exponentially. FIG. 2 is an example of such a weight table that has 512 entries (addresses and data for pixel numbers 0 to 511). For the drawing ellipsis are used to designate missing rows. Note, however, that despite having 512 addresses, there are only ten unique values for data to be retrieved. As shown in the left-hand column of FIG. 2, pixel number 0 has a pixel address in binary of nine zeros, and has associated with it a data value of 6. Pixel 1 will have a pixel address 0 0000 0001 and has associated with it a data value of 18. Pixels 2 has an address of 0 0000 0010 and an associated data value of 30. Pixel 3 has an address of 0 0000 0011. As shown further down in the table, to generalize ranges of addresses can be represented by the more significant bits, with less significant bits represented by X, which can be either 0 or 1. As shown by the table, the data value for a particular range of pixels can be addressed based simply on the position of the first “1 ” in the binary address or the number of leading zeros. For example, as shown, pixels 128-255 will all have addresses of 0 1XXX XXX and a resulting data value of 102. Observing the table written in the manner of FIG. 2 shows that the number of leading zeros in the pixel address exactly describes all of the pixels with the same weight or data value, and the data value for all of those pixels can be described by one entry in the lookup table. Thus, the lookup table can be stored in a considerably smaller region of memory and accessed considerably faster than if the full 512 entries were required. In the example discussed, implementation for an H.264 motion estimation engine is used. It should be understood, however, that the concepts described herein are applicable to other technologies, and in general, to lookup tables in which there is redundant information in the data values.

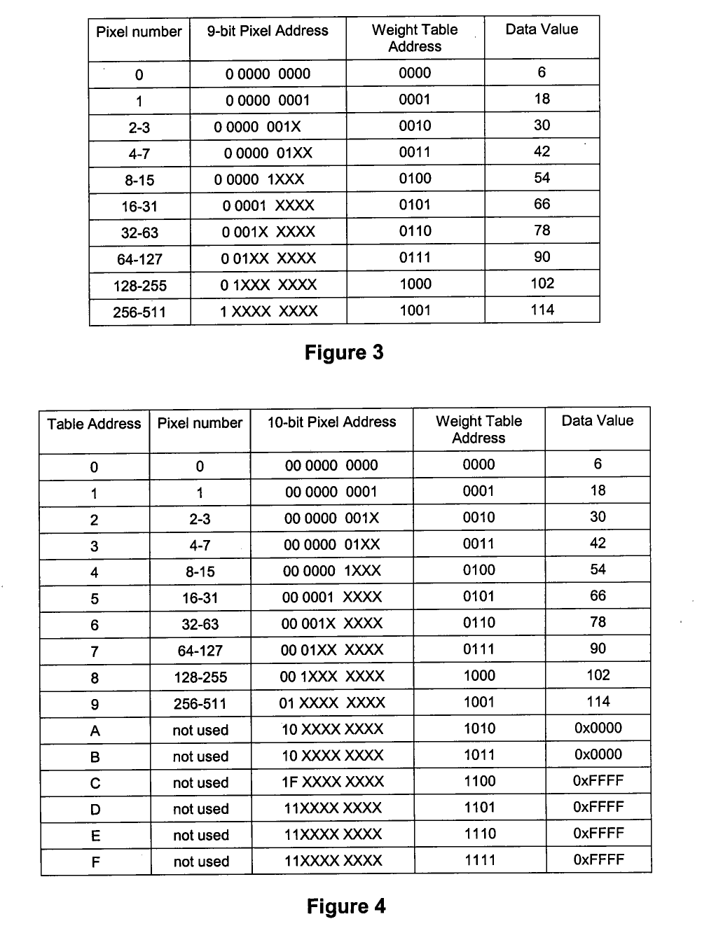

FIG. 3 illustrates a further improvement in the implementation of the lookup table in which the number of leading zeros is used to establish a weight table address where there is one row for each data value. In essence as shown in FIG. 3, each set of matching data values has one weight table address, where that address reflects the matching data values for a differing number of pixels. FIG. 4 is a variation of FIG. 3 in which the same initial ten entries from FIG. 3 are used; however, six more entries are provided to allow for constant values of particular data values. Of course, the values illustrated are hypothetical. The particular values depicted in effect disable use of the table by, in essence, adding in a zero weight or a full scale weight. In the depicted embodiment, an additional pixel address bit enables these additional data values. Of course, in a hardware implementation an additional wire could be used to perform the same function.

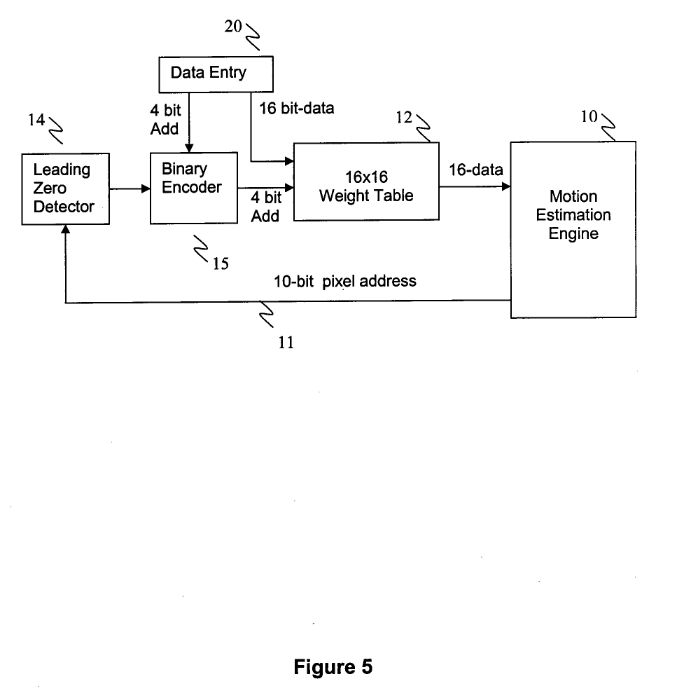

FIG. 5 is a block diagram of an implementation for the lookup table as shown in FIG. 4. As shown in FIG. 5, a video processing motion estimation engine is connected to communicate with the weight table 12. In operation the motion estimation engine 10 sends pixel addresses over bus 11 for the needed pixel data. The addresses are received at a leading zero detector 14 which detects the number of leading zeros, and provides that information to the binary encoder 15. Binary encoder 15 generates a weight table address, for example of the format shown in FIG. 4. That 4 bit address is used to access the weight table 12. In response the weight table provides the retrieved data value for the desired pixel to the motion estimation engine.

Data can be loaded into the weight table or the binary encoder via a data entry module 20. The data value is provided to the weight table 12 and the 4 bit weight table address for that data is provided to the binary encoder. The implementation of FIG. 5 is an example of one weight table, such as might be used for the horizontal weights for pixels in a compression system. A similar structure and table can also be provided for the vertical pixel weights.

Numerous circuit implementations for lookup tables are well known. Implementations of a leading zero detector and a binary encoder are well known, however, logic equations for such implementations such as for FIG. 4 are shown below. Table 1 shows logic equations for implementation of a leading zero detector. In the table, “pa” represents pixel address, “npa” represents not pixel address, and the ampersand (&) represents the logic operation “AND.”

TABLE 1
Leading Zero Detector

| Table | |
|---|---|
| Address | Logic Equation |
| C to F | pa9 & pa8 |
| A and B | pa9 & npa8 |
| 9 | npa9 & pa8 |
| 8 | npa9 & npa8 & pa7 |
| 7 | npa9 & npa8 & npa7 & pa6 |
| 6 | npa9 & npa8 & npa7 & npa6 & pa5 |
| 5 | npa9 & npa8 & npa7 & npa6 &n pa5 & pa4 |
| 4 | npa9 & npa8 & npa7 & npa6 & npa5 & npa4 & pa3 |
| 3 | npa9 & npa8 & npa7 & npa6 & npa5 & npa4 & npa3 & |
| | pa2 |
| 2 | npa9 & npa8 & npa7 & npa6 & npa5 & npa4 & npa3 & |
| | npa2 & pa1 |
| 1 | npa9 & npa8 & npa7 & npa6 & npa5 & npa4 & npa3 & |
| | npa2 & npa1 & pa0 |
| 0 | npa9 & npa8 & npa7 & npa6 & npa5 & npa4 & npa3 & |
| | npa2 & npa1 & npa0 |

Using the same naming conventions as in Table 1, the logic equations for the binary encoder are shown in Table 2 below. In Tables 2, the vertical line represents the logic operation “OR.”

TABLE 2
Binary Encoder

| Bit | Logic Equation |
|---|---|
| 1 | pa0 \| pa2 \| pa4 \| pa6 \| pa8 |
| 2 | pA1 \| pa2 \| pa5 \| pa6 \| (pa9 & npa8) |
| 4 | pa3 \| pa4 \| pa5 \| pa6 \| (pa9 & pa8) |
| 8 | pa7 \| pa8 \| pa9 |

The system described above for improving table lookup has been described in terms of a hardware implementation. Software implementations may also be employed. In a software implementation large table lookups often have a problem known as cache line victimization. A typical cache line in most computers is on the order of 16 to 64 bytes. As the motion estimation engine moves around the search window, the cache will eventually fill with data, e.g., 512 entries, meaning on the order of 1000 kilobytes. This is a large amount of data for a cache memory, particularly when there are really only ten unique data entries, occupying on the order of 20 bytes. This results in victimizing good data in the cache, and causing significant bus traffic, in addition to slowing cache access.

Furthermore, many digital signal processors have small fast memories in addition to their cache memories. These smaller memories are usually on the order of 4 kilobytes in size. The table of this invention fits into this fast memory; however, the large size of the table poses the same problem as the cache memory, that is a systematic reduction in the size of the cache in exchange for 20 bytes of unique data.

The invention described herein illustrates how to dramatically reduce the cache line victimization and data memory problems. In particular, by employing an instruction that counts the number of leading zeros, an address may be used to retrieve the appropriate data value. If desired, the leading zero count can be subtracted from a pointer address to get the data value from one of the ten unique data entries. For example, if the lookup table of FIG. 4 is employed, the pseudo code below will perform the table lookup.

i = top of table pointer

| | |
|---|---|
| i = i + 20 | // table address = top of table pointer + 20 bytes |
| p = pixel address | // address in bytes |
| lzc d, p | // leading zero count of pixel address p in d reg |
| wa = i − d | // weight address = add table address − p |
| load wa | // load weight value from table |

The data in the table can be rearranged to allow for different accesses or different constants to be used with the top of table pointer.

Although a preferred embodiment has been described, various changes, and substitutions are intended in the present invention. In some instances, features of the invention can be employed without a corresponding use of other features, without departing from the scope of the invention as set forth below. Therefore, many modifications may be made to adapt a particular configuration or method disclosed, without departing from the essential scope and spirit of the present invention. It is intended that the invention not be limited to the particular embodiment disclosed, but that the invention will include all embodiments and equivalents falling within the scope of the claims.

What is claimed is:

1. A system for providing data from a lookup table comprising:
a video processing engine which provides a pixel address as an output signal, some pixel addresses having a number of leading zeros in the pixel address;
a leading zero detector which receives the pixel address and in response determines the number of leading zeros and provides that information;
a binary encoder coupled to the leading zero detector to convert the information received from the leading zero detector into a lookup table address; and
a lookup table coupled to the binary encoder to receive the lookup table address and in response provide a data value associated with that address to the video processing engine.

2. A system as in claim 1 further comprising a data entry module coupled to the lookup table and to the binary encoder for providing addresses and data values to the lookup table and to the binary encoder.

3. A system as in claim 1 wherein all entries in the lookup table having a same data value have the same number of leading zeros in their pixel addresses.

4. A system as in claim 3 wherein the video processing engine executes motion estimation algorithms.

5. A system as in claim 4 wherein the lookup table provides pixel weights for the motion estimation engine.

6. A system as in claim 5 wherein for an integer n, a number of pixels 2ⁿ have the same data value.

7. In a video system having a table of data values associated with pixels having pixel addresses, a method of retrieving the data values comprising:
assigning data values to pixels to cause pixels having the same data value to have a same number of leading zeros in pixel addresses;
storing the data values in a table indexed by the number of leading zeros in the pixel addresses;
when the video system requires a data value for a selected pixel, determining the number of leading zeros in the pixel address of the selected pixel; and
using the number of leading zeros in the pixel address, retrieving the data value for the selected pixel.

8. A method as in claim 7 wherein the step of determining the number of leading zeros in the pixel address comprises providing the pixel address to a leading zero detector to calculate the number of leading zeros in the pixel address.

9. A method as in claim 8 further comprising encoding the number of leading zeros in the pixel address as a multi-digit binary number.

10. A method as in claim 8 further comprising using the multi-digit binary number to access the table.

11. A method for performing faster table lookup operations in a computing system wherein the lookup table includes redundant information, the method comprising:
creating a lookup table having a series of data values associated with addresses, some of the data values being used more than once in the table;
organizing the table such that all entries having the same data value have a same number of leading zeros in their address;
when a data value is to be retrieved, using the number of leading zeros as an index into the table to select the data value;
retrieving the data value and using the retrieved data value in a computer processing operation.

12. A method as in claim 11 wherein the data values comprise information about pixel locations in an image.

13. A method as in claim 12 wherein the step of using the number of leading zeros comprises providing the address to a leading zero detector to calculate the number of leading zeros in the address.

14. A method as in claim 13 further comprises encoding the number of leading zeros in the address as a multi-digit binary number.

15. A method as in claim 14 further comprising providing the multi-digit binary number to the lookup table to retrieve the data value.
